(19) United States
(12) Patent Application Publication
(10) Pub. No.: US 2015/0192170 A1
(43) Pub. Date: Jul. 9, 2015

(54) Cable Control Device

(71) Applicant: Valeo Systemes Thermiques, Le Mesnil Saint Denis (FR)

(72) Inventor: Jean-Yves Queinnec, Elancourt (FR)

(21) Appl. No.: 14/409,916

(22) PCT Filed: Jun. 19, 2013
(86) PCT No.: PCT/EP2013/062688

§ 371 Date: Dec. 19, 2014

(30) Foreign Application Priority Data
Jun. 21, 2012 (FR) 1255861

(51) Int. Cl. F16C 1/10; F16C 1/26

(52) U.S. Cl. CPC F16C 1/102; F16C 1/262; F16C 1/106

(57) ABSTRACT

The invention concerns a cable control device (1) comprising: at least one protective sheath (2), and at least one attachment flange (11) for attaching the protective sheath (2) to a support. The protective sheath (2) comprises at least one lateral attachment wing (15) extending radially outside the protective sheath (2).

The present invention concerns the technical field of cable control devices, also known as “Bowden” control devices.

Such a cable control device includes a control cable mobile in translation inside a protective sheath. The control cable transmits movement from a driving maneuvering member to a driven maneuvering member via the protective sheath. Respective ends of the control cable are fixed to the driven maneuvering member and the driving maneuvering member.

Such cable control systems find numerous applications in the automotive field, notably for transmitting movements of a gear lever to a gearbox, for controlling mechanisms for opening doors or hatches of a vehicle or for controlling the movement of flaps in ventilation and/or air-conditioning units of the vehicle, although this list is neither exhaustive nor limiting on the invention.

For the transmission of movement by the control cable to be as precise as possible, it is necessary to adjust the length of the path of the control cable optimally so as to minimize the play or ‘dead’ travel of the control cable as a function of the forces to be transmitted and the forces liable to be applied by the driving maneuvering member.

One way to carry out such adjustment consists in adjusting the distance between, on the one hand, a fixed end of the protective sheath and, on the other hand, the driven maneuvering member or the driving maneuvering member.

To this end, systems have been proposed for fixing one end of the protective sheath employing means for adjusting the position of the protective sheath by means of screw systems or spring systems offering automatic or semi-automatic adjustment.

Such adjustment systems do enable the required adjustment of the travel of the control cable but have the disadvantage of being relatively costly to manufacture because of the complexity of the parts used.

There has therefore emerged the requirement for a new cable control system allowing as precise as possible adjustment of the travel of the control cable whilst employing simple manufacturing means and that is of low cost.

To achieve such an objective, the present invention concerns a cable control device including
at least one protective sheath, optionally at least one control cable mobile in translation inside the protective sheath, and at least one plate for fixing the protective sheath to a support.

In accordance with the invention, the protective sheath includes at least one lateral fixing flange extending radially outside the protective sheath and advantageously plastically deformable.

The fixing plate preferably includes a jaw assembly comprising a first jaw and a second jaw adapted to pinch the lateral fixing flange in a closed position of the jaw assembly.

To this end, in accordance with an additional feature of the present invention, the first jaw includes at least one pinch surface adapted to cooperate with at least one pinch surface of the second jaw in order to grip the lateral fixing flange in a closed position of the jaw assembly.

In a complementary manner, the pinch surface of the first jaw and/or the pinch surface of the second jaw include(s) at least one immobilizing stud. Moreover, the pinch surface of the first jaw and/or the pinch surface of the second jaw may include at least one immobilizing cavity.

In such an arrangement, in the closed position of the jaw assembly the immobilizing stud of the pinch surface of the first jaw, respectively the second jaw, cooperates with the immobilizing cavity of the pinch surface of the second jaw, respectively the first jaw, in order to deform the lateral fixing flange.

The use of such a lateral fixing flange attached to the protective sheath and pinched by the first jaw and the second jaw of the jaw assembly of the fixing plate makes it possible to implement the function of fixing the end of the protective sheath in a simple manner.

Moreover, simply pinching the lateral fixing flange between the first jaw and the second jaw allows easy adjustment of the position of the corresponding end of the protective sheath by simply opening and closing the jaw assembly of the fixing plate.

Moreover, such an arrangement enables prevention of sliding of the lateral fixing flange between the first jaw and the second jaw when the jaw assembly is closed. In fact, the plastic deformation of the lateral fixing flange ensures positive immobilization against movement in longitudinal translation in either direction and therefore positive immobilization of the protective sheath connected to the lateral fixing flange, also in both directions of movement in longitudinal translation.

In accordance with one embodiment of the invention, the jaw assembly is adapted to surround at least one protective sheath when in the closed position. The trapping of the protective sheath by the jaw assembly enables perfect immobilization of the protective sheath.

In accordance with another feature, the first jaw, respectively the second jaw, includes at least one reception indentation adapted to receive the protective sheath.

In accordance with another variant embodiment, when the control device includes two protective sheaths, the first jaw, respectively the second jaw, includes two indentations to receive a respective protective sheath. In such a configuration, the two reception indentations are preferably separated by a surface for pinching the lateral fixing flange.

In accordance with other features of the present invention, the first jaw and the second jaw are connected by an articulation. The fixing plate may moreover include locking means enabling joining together of the first jaw and the second jaw in the closed position of the jaw assembly.

The use of such an articulation enables the opening and closing movements of the jaw assembly to be facilitated and prevents loss of component parts of the jaw assembly, notably the first jaw and/or the second jaw.

In accordance with another feature of the invention, the fixing plate includes means for locking the first jaw and the second jaw in the closed position of the jaw assembly.

In accordance with a variant embodiment, the fixing plate is rigidly connected to an adapter plate on the support. The use of such an adapter plate on the support makes it possible to facilitate integration of the control device in accordance with the present invention into the system it controls.

The fixing plate and the corresponding adapter plate preferably form a one-piece assembly. This variant embodiment is particularly suitable for manufacture of the fixing plate and the adapter plate by injection molding plastic material.

One particular embodiment of the present invention is such that the cable control device includes two protective sheaths, preferably inside which is disposed a control cable mobile in translation relative to the respective protective sheath, connected to each other at one of their ends at least by the lateral fixing flange extending radially between the two protective sheaths.

Alternatively, the cable control device includes two protective sheaths including a respective lateral fixing flange.

Such a control device in accordance with the invention is particularly suitable for controlling a system in which the control cables function in traction to move a driven maneuvering member in two opposite directions.

In accordance with another alternative embodiment, the protective sheath includes respective lateral fixing flanges arranged at each of the ends of the protective sheath.

Moreover, the cable control device in accordance with the present invention advantageously includes two fixing plates arranged at respective ends of the protective sheath.

Finally, in accordance with complementary features, the adapter plate carries at least one maneuvering member mobile in rotation to which is fixed at least one control cable mobile in translation relative to the protective sheath.

Moreover, the adapter plate may include means for guiding at least one control cable, advantageously situated between the fixing plate and the maneuvering member.

Of course, the various features, variants and/or embodiments of the present invention may be combined with one another in diverse combinations provided that they are not incompatible or mutually exclusive.

The present invention will be better understood and other features and advantages will become more apparent on reading the following detailed description covering embodiments provided by way of illustration and given with reference to the appended figures, provided by way of nonlimiting example, which may serve to add to the understanding of the present invention and to the description of its implementation and, where appropriate, contribute to its definition, in which figures:

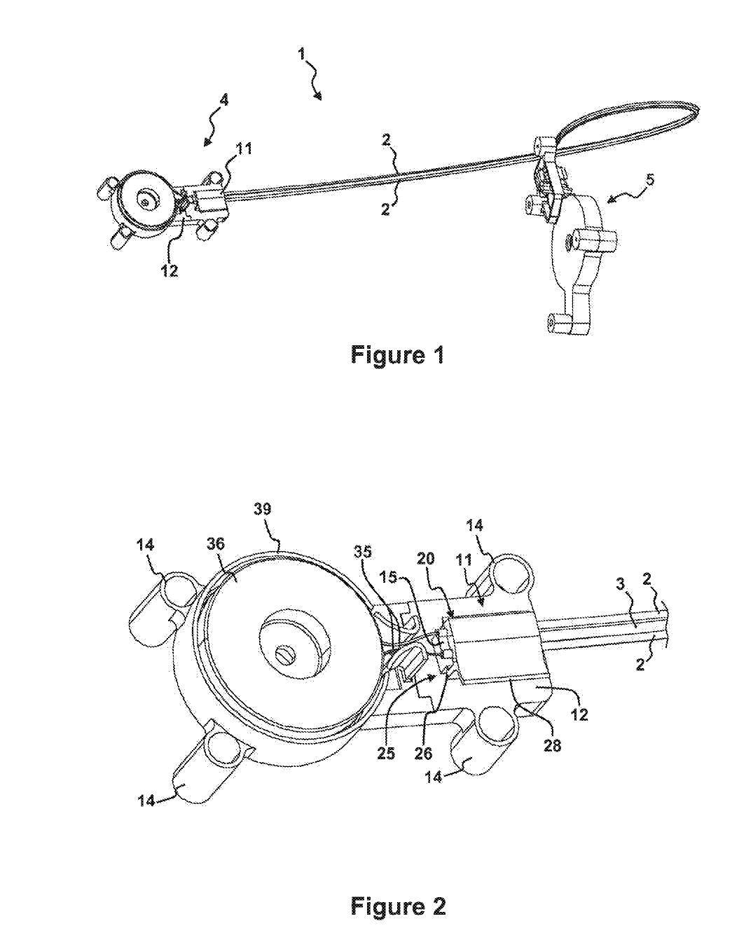

FIG. 1 is a perspective view of a cable control device in accordance with the present invention,

FIG. 2 is a perspective view of one end of the cable control device from FIG. 1,

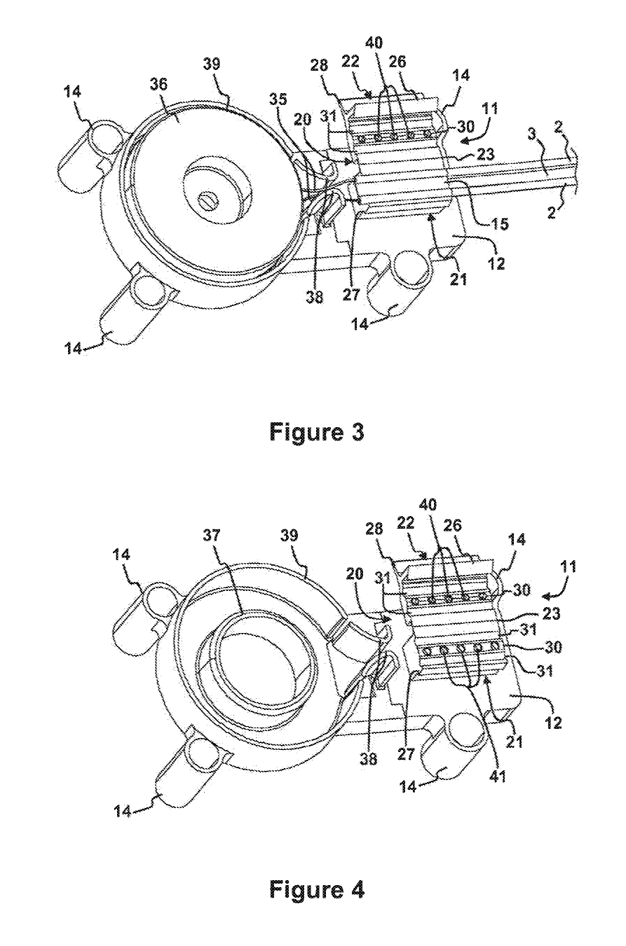

FIG. 3 is a perspective view of one end of the cable control device from FIG. 2, showing a fixing plate in an open position, and

FIG. 4 is a perspective view of one end of the cable control device from FIG. 2, showing in detail the fixing plate in the open position.

It is to be noted that, in the figures, structural and/or functional elements common to the various embodiments may bear the same reference numbers. Accordingly, unless otherwise indicated, such elements have identical structural, dimensional and material properties.

FIG. 1 is a perspective view of a cable control device 1 in accordance with the present invention. The cable control device 1 includes at least one protective sheath 2 that is advantageously flexible.

In accordance with the example shown in FIG. 1, the cable control device 1 includes two protective sheaths 2.

In accordance with one particular embodiment, the two protective sheaths 2 are fastened together, at least at separate points and advantageously over their entire length, by a flexible spacer 3, seen better in FIGS. 2 and 3. Such a flexible spacer 3 makes it possible to facilitate the manipulation of the control device in accordance with the invention and is of course optional.

The protective sheath 2 extends between a first end 4 and a second end 5 of the cable control device 1, constituting respective control means. Such control means enable integration of the control device in accordance with the present invention into a more complex system to transmit movement therein between two mobile members at a distance from one another.

In accordance with the example shown, the first end 4 and a second end 5 of the cable control device 1 are substantially identical and associated with substantially similar mechanical components. Also, only the first end 4 of the cable control device 1 will be described hereinafter, given that an identical description applies to the second end 5 of the cable control device 1 where the components are concerned.

The first end 4 is adapted to be fixed to a support, not shown, of the system into which the cable control device 1 is integrated, for example a casing of a vehicle ventilation and/or air-conditioning unit or a control panel of such a ventilation and/or air-conditioning unit.

The first end 4 of the cable control device 1 includes at least one fixing plate 11 adapted to constitute means for fixing the protective sheath 2 to the first end 4 of the cable control device 1.

To this end, the fixing plate 11 is rigidly connected to an adapter plate 12. Moreover, the adapter plate 12 contributes to the fixing of the first end 4 to the support of the system into which the cable control device 1 is integrated.

In accordance with the embodiment shown, the fixing plate 11 and the adapter plate 12 form a one-piece assembly, notably obtained by injection molding plastic material.

Alternatively, the fixing plate 11 could be added to the adapter plate 12 and fixed to the latter by any appropriate means. Such appropriate means comprise, for example, a device employing elastic hooks to immobilize the fixing plate 11, for example in a receiving housing provided in the adapter plate 12, or a system of screws attaching the fixing plate 11 to the adapter plate 12.

Moreover, the adapter plate 12 further includes attachment means 14 enabling retention of the first end 4 on the support of the system into which the cable control device 1 is integrated. As shown in the figures, the attachment means 14 are for example formed by bores adapted to enable the fitting of fixing screws, not shown.

Refer from now on to FIG. 2, which is a perspective view of the first end 4 of the cable control device 1 from FIG. 1.

In accordance with one particular embodiment, the cable control device 1 includes at least one lateral fixing flange 15. Such a lateral fixing flange 15 extends radially outside the protective sheath 2. In accordance with the example shown, particularly in FIG. 3, the lateral fixing flange 15 connects together two protective sheaths 2, preferably starting from their ends and over a limited length, in particular corresponding to a few centimeters. For example, the lateral fixing flange 15 is molded onto the corresponding end of the two protective sheaths 2. Alternatively, each protective sheath 2 includes a respective lateral fixing flange 15.

In order to fix the protective sheath 2 to the first end 4 of the cable control device 1, the fixing plate 11 includes a jaw assembly 20. The jaw assembly 20 is formed of a first jaw 21 and a second jaw 22. The first jaw 21 and the second jaw 22 are mobile between a closed position of the jaw assembly 20, as shown in FIG. 2, and an open position of the jaw assembly 20, as shown in FIGS. 3 and 4.

In the closed position of the jaw assembly 20, the first jaw 21 and the second jaw 22 cooperate in order to retain elements disposed between them. In the open position of the jaw assembly 20, the first jaw 21 and the second jaw 22 are separated in order to release the elements disposed between them.

The jaw assembly 20 enables gripping of the lateral fixing flange 15 between the first jaw 21 and the second jaw 22.

To be more precise, FIGS. 3 and 4 are perspective views of the first end 4 of the cable control device 1 from FIG. 2, respectively showing the fixing plate 11 in the open position and in more detail with the two protective sheaths 2 removed.

In accordance with the example shown, the first jaw 21 is rigidly connected to the plate 12 while the second jaw 22 is connected to the first jaw 21 by an articulation 23.

In particular, the articulation 23 is a hinge formed by a film of plastic material produced when manufacturing the first jaw 21 and the second jaw 22 by a molding process.

The use of such an articulation 23 prevents loss of the second jaw 22 when the jaw assembly 20 is in the open position.

The fixing plate 11 also includes locking means 25 for joining together the first jaw 21 and the second jaw 22 in the closed position.

In accordance with the embodiment shown, the locking means 25 are formed by a hook 26 and a shoulder 27. The hook 26 is fastened to the second jaw 22. The hook 26 is preferably situated opposite the articulation 23. Moreover, the shoulder 27 is fastened to the first jaw 21. The hook 26 is intended to interengage with the shoulder 27.

The interengagement of the hook 26 with the shoulder 27 is effected by elastic deformation of the hook 26. The elastic deformation of the hook 26 is obtained by virtue of the inherent elasticity of the material constituting the first jaw 21 and the second jaw 22. Additionally and/or instead of this, the elastic deformation of the hook 26 is obtained by virtue of the geometry of the hook 26.

In order to enable opening of the jaw assembly 20, the second jaw 22 includes a holding member 28 situated along the hook 26 opposite the articulation 23.

In accordance with various alternative embodiments, the first jaw 21 and the second jaw 22 are connected to each other by another type of connecting member. One such other type of connecting member may be a tie such as a plastic filament, for example.

Alternatively, the locking means 25 may be formed by two hooks 26 disposed on respective opposite sides of the fixing plate 11 and cooperating with a respective shoulder 27.

Moreover, the first jaw 21 and the second jaw 22 may be two distinct and separate parts.

Finally, the locking means 25 enabling joining together of the first jaw 21 and the second jaw 22 in the closed position may consist of clips or joining means, such as screws.

Moreover, in order to enable coherent joining, it is possible to arrange a centering member between the first jaw 21 and the second jaw 22.

The first jaw 21 and the second jaw 22 have respective working faces intended to come into contact with the protective sheath 2.

In accordance with the present invention, the working faces of the first jaw 21 and the second jaw 22 are intended to cooperate in the closed position of the jaw assembly. Such cooperation of the working faces of the first jaw 21 and the second jaw 22 provides at least two pinch surfaces 30 that grip the protective sheath 2.

In accordance with the present invention, the working faces of the first jaw 21 and the second jaw 22 preferably constitute two pinch surfaces 30 that grip the lateral fixing flange 15. Alternatively, the working faces of the first jaw 21 and the second jaw 22 constitute two pinch surfaces 30 that grip a respective lateral fixing flange 15 of each protective sheath 2.

The pinch surfaces 30 are placed so that each is in contact with one face of the lateral fixing flange 15 when the first jaw 21 and the second jaw 22 are in the closed position of the jaw assembly.

To be more specific, the pinch surface 30 of the first jaw 21, respectively the pinch surface 30 of the second jaw 22, is adjacent at least one reception indentation 31. The reception indentation 31 is adapted to receive a protective sheath 2.

In accordance with the present invention, the number of reception indentations 31 adjacent the pinch surface 30 of the first jaw 21, respectively the pinch surface 30 of the second jaw 22, is equal to the number of protective sheaths 2 of the cable control device 1.

Accordingly, as shown in FIGS. 3 and 4, the first jaw 21, respectively the second jaw 22, includes two reception indentations 31 disposed on respective opposite sides of the pinch surface 30 of the first jaw 21, respectively the pinch surface 30 of the second jaw 22.

The reception indentations 31 are arranged in the working faces of the first jaw 21 and the second jaw 22. The reception indentations 31 advantageously have a shape complementary to the exterior shape of the protective sheaths 2 so as to espouse the shape of the protective sheaths 2 when the jaw assembly 20 is closed.

When the protective sheaths 2 intended to be housed in the reception indentations 31 are of circular section the reception indentations 31 preferably have a semicylindrical shape and extend parallel to each other on respective opposite sides of the corresponding pinch surface 30.

The control device 1 includes at least one control cable 35. The control cable 35 is preferably disposed inside the protective sheath 2 so as to be able to move in translation therein, advantageously without play.

In accordance with one embodiment, each protective sheath 2 contains a single control cable 35 sliding inside it. Alternatively, each protective sheath 2 contains a plurality of control cables 35 sliding inside it.

One end of the control cable 35 is intended to be attached to a maneuvering member 36. The maneuvering member 36 is adapted to be mobile in rotation and guided by guide means formed by a bearing 37 disposed on the adapter plate 12.

The maneuvering member 36 further includes means, not visible, for coupling it to a member to be controlled, notably a pivot pin of a flap.

The end of the control cable 35 may be attached to the maneuvering member 36 in any appropriate manner, for example by means of a ball crimped or molded onto the control cable 35.

The resulting cable control device 1 is manufactured and assembled in the following manner.

The adapter plate 12 and the fixing plate 11 are manufactured by injection molding plastic material. The adapter plate 12 and the fixing plate 11 are preferably molded simultaneously and form a one-piece part. Alternatively, the adapter plate 12 and the fixing plate 11 are molded separately and are subsequently joined to each other. Also manufactured are the respective maneuvering members 36 intended to equip the first end 4 and the second end 5.

Moreover, the protective sheath 2 is cut to the necessary length. Moreover, in accordance with one particular embodiment, when the cable control device 1 includes two protective sheaths 2, the protective sheaths 2 may optionally be overmolded, at least locally, to form the spacer 3.

Moreover, the protective sheaths 2 are overmolded at their ends in order to define the lateral fixing flanges 15.

The control cables 35 are then placed inside the protective sheaths 2 and cut to the necessary length. Attachment means, for example balls, are molded onto or fixed to the free ends of the control cables 35.

For the final assembly of the cable control device 1 in accordance with the invention, the two adapter plates 12 are placed on an assembly bench, not shown, so as to be separated by a distance equal to the length of the cable control device 1 integrated into the system for which it is intended. The ends of the control cables 35 are then attached to the maneuvering members 36 disposed on their respective bearings 37.

It is to be noted that, in accordance with the example shown, each adapter plate 12 includes guide means 38 for the control cables 35. The guide means 38 are placed between the fixing plate 11 and the maneuvering member 36 so as to prevent unintentional detachment of the control cables 35. The guide means 38 are formed by convex surfaces against which the control cables 35 slide, for example.

The adapter plate 12 further includes a peripheral wall 39 surrounding the maneuvering member 36 to protect it and to prevent detachment of the control cables 35 whilst allowing the control cables 35 to pass between the guide means 38.

Once the maneuvering members 36 with the ends of the control cables 35 attached are in place on the adapter plate 12, the ends of the protective sheaths 2 are placed on the first jaw 21 so that the protective sheaths 2 are positioned in the corresponding reception indentations 31 and the lateral fixing flange 15 placed against the corresponding pinch surface 30.

Thereafter, the second jaw 22 is then placed in the closed position so as to trap the protective sheaths 2 and to pinch the lateral fixing flange 15 or the lateral fixing flanges 15.

Accordingly, the protective sheaths 2 are immobilized against movement in translation relative to the fixing plate 11 by the pinching effect of the jaw assembly 20.

In a complementary way, in order to reinforce this immobilization against movement in longitudinal translation, the pinch surface 30 of the first jaw 21, respectively the second jaw 22, includes at least one immobilizing stud 40. In accordance with the example shown, the pinch surface 30 includes five immobilizing studs 40. The immobilizing stud 40 is a concave shape projecting from the pinch surface 30.

Moreover, the pinch surface 30 of the first jaw 21, respectively the second jaw 22, preferably includes at least one immobilizing cavity 41. In accordance with the example shown, the pinch surface 30 includes five immobilizing cavities 41. The immobilizing cavity 41 is a convex shape on the pinch surface 30.

In the closed position of the jaw assembly 20, the immobilizing stud 40 of the first jaw 21 preferably cooperates with the immobilizing cavity 41 of the second jaw 22.

Each immobilizing stud 40 of the first jaw 21 is advantageously intended to cooperate with a respective immobilizing cavity 41 of the second jaw 22 to bring about plastic deformation of the lateral fixing flange 15, respectively the lateral fixing flanges 15, so as to provide complementary immobilization.

In a reciprocal manner, in the closed position of the jaw assembly 20, each immobilizing cavity 41 of the first jaw 21 is intended to cooperate with a respective immobilizing stud 40 of the second jaw 22 to bring about plastic deformation of the lateral fixing flange 15, respectively the lateral fixing flanges 15, so as to provide additional immobilization.

The material constituting and/or the dimensions of the lateral fixing flange 15, respectively the lateral fixing flanges 15, is or are then adapted to make it plastically deformable as a result of the conjugate effect of the immobilizing stud(s) 40 and the immobilizing cavity or cavities 41.

Given the deformable nature of the lateral fixing flange 15, respectively the lateral fixing flanges 15, the protective sheath 2 can be immobilized in any position of the fixing flange 15, respectively the lateral fixing flanges 15, in the jaw assembly 20. Such a possibility of immobilization in any position would not be achieved if the lateral fixing flange 15 were provided with pre-molded shapes intended to cooperate with the immobilizing stud(s) 40 and the immobilizing cavity or cavities 41 of the pinch surfaces 30.

Once assembled, the cable control device 1 can be integrated into a system in which it will transmit movement between the two maneuvering members 36 coupled to a driving system and to a driven system. During such integration, the holding member 28 can be used to open the jaw assembly 20 so as to adjust the cable control device 1 and notably the set of control cables 35.

In accordance with the example described above, the cable control device 1 in accordance with the invention includes two protective sheaths 2 associated with a respective control cable 35. However, a cable control device 1 in accordance with the invention may include only one protective sheath 2 associated with a single control cable 35.

Similarly, in accordance with the example described above, the fixing plate 11 is fastened to an adapter plate 12. However, the cable control device 1 in accordance with the invention does not necessarily include an adapter plate 12 and may include only the fixing plates 11 provided with means 14 for fixing them to a support, not shown.

The invention is obviously not limited to the embodiments described above by way of example only. It encompasses diverse modifications, alternative shapes and other variants within the scope of the present invention that the person skilled in the art might envisage and notably all combinations of the various modes of operation described above, separately or in combination.

1. A cable control device (1) including:
at least one protective sheath (2), and
at least one plate (11) for fixing the protective sheath (2) to a support, wherein the protective sheath (2) includes at least one lateral fixing flange (15) extending radially outside the protective sheath (2).

2. The cable control device (1) as claimed in claim 1, wherein the lateral fixing flange (15) is plastically deformable.

3. The cable control device (1) as claimed in claim 1, wherein the fixing plate (11) includes a jaw assembly (20) comprising a first jaw (21) and a second jaw (22) adapted to pinch the lateral fixing flange (15) in a closed position of the jaw assembly (20).

4. The cable control device (1) as claimed in claim 3, wherein the first jaw (21) includes at least one pinch surface (30) adapted to cooperate with at least one pinch surface (30) of the second jaw (22).

5. The cable control device (1) as claimed in claim 4, wherein the pinch surface (30) of the first jaw (21) and/or the pinch surface (30) of the second jaw (22) include(s) at least one immobilizing stud (40).

6. The cable control device (1) as claimed in claim 3 or 4, wherein the pinch surface (30) of the first jaw (21) and/or the pinch surface (30) of the second jaw (22) include at least one immobilizing cavity (41).

7. The cable control device (1) as claimed in claim 5, wherein in the closed position of the jaw assembly (20), the immobilizing stud (40) of the pinch surface (30) of one of the first jaw (21) and the second jaw (22) cooperates with the immobilizing cavity (41) of the pinch surface (30) of the other of the first jaw (21) and the second jaw (22).

8. The cable control device (1) as claimed in claim 3, wherein the first jaw (21) and the second jaw (22) are connected by an articulation (23).

9. The cable control device (1) as claimed in claim 3, wherein the fixing plate (11) includes locking means (25).

10. The cable control device (1) as claimed in claim 3, wherein the first jaw (21) and/or the second jaw (22) include at least one reception indentation (31).

11. The cable control device (1) as claimed in claim 1, including two protective sheaths (2) connected to each other at one of their ends at least by the lateral fixing flange (15) extending radially between the two protective sheaths (2).

12. The cable control device (1) as claimed in claim 1, including two protective sheaths (2) including a respective lateral fixing flange (15).

13. The cable control device (1) as claimed in claim 1, wherein the protective sheath (2) includes two lateral fixing flanges (15) at respective ends of the protective sheath (2).

14. The cable control device (1) as claimed in claim 1, including two fixing plates (11) at respective ends of the protective sheath (2).

15. The cable control device (1) as claimed in claim 2, wherein the fixing plate (11) includes a jaw assembly (20) comprising a first jaw (21) and a second jaw (22) adapted to pinch the lateral fixing flange (15) in a closed position of the jaw assembly (20).

16. The cable control device (1) as claimed in claim 4, wherein the pinch surface (30) of the first jaw (21) and/or the pinch surface (30) of the second jaw (22) include at least one immobilizing cavity (41).
